(19) United States
(12) Patent Application Publication
(10) Pub. No.: US 2004/0157025 A1
(43) Pub. Date: Aug. 12, 2004

(54) Ream wrapper for heat seal application wrap lines

(76) Inventor: Gary H. Knauf, Bear Creek, WI (US)

Correspondence Address: Hoffman, Wasson & Gitler, P.C., Suite 522, 2361 Jefferson Davis Highway, Arlington, VA, 22202, US

(21) Appl. No.: 10/359,160

(22) Filed: Feb. 6, 2003

(51) Int. Cl. B32B 1/08

(52) U.S. Cl. 428/36.91

(57) ABSTRACT

The wrapper for a ream of paper has an inner surface coated with polyethylene. When the wrapper is formed about a ream of paper, the inner layer overlaps and contacts the outer layer along a longitudinal seam. The polyethylene layer is used to create a seal with the application of heat. Areas of the inner surface in proximity to a heat source during the heat sealing process and where a seal will not be beneficial are covered with a heat shield, such as a varnish. In this way, damage to the paper is avoided. The varnish includes Styrenated Acrylic polymer, with Kaolin Clay and ink. The varnish is applied to the wrapper during the same manufacturing process as the polyethylene coating.

### FIELD OF THE INVENTION

The invention relates to a wrapper for reams of paper that may be heat sealed without damaging the paper.

### BACKGROUND OF THE INVENTION

Paper sheets are packaged for shipping and storage in ream quantities of 500 sheets. Each ream of sheets is wrapped by a tubular shaped overwrap having a longitudinal seal. After the tubular form is shaped, the ends are folded to complete the package. To maintain the wrapper in closed position, adhesives or heat seals are used. The cost of hot melt adhesives includes not only the adhesive itself, but also the machinery to apply the adhesive to the wrapper as well as downtime needed to clean adhesive off of machine parts which become coated due to jambs and feed problems.

Some heat sealed wrappers use a coating of low density polyethylene (LDPE) on one surface. The LDPE is softened to a point to allow bonding of the coated surface to the opposite surface of the wrapper. Often, the degree of heating and pressure necessary to effectuate a heat seal causes the polyethylene to bond to the wrapped product.

U.S. Pat. No. 5,250,348 (Knauf) discloses the application of a layer of polyamine, for example, polyethyleneimine (P.E.I.) coated onto the paper substrate on the side opposite of the LDPE. The use of P.E.I. allows the use of low temperature and pressure to effect a heat seal. When sealing carbonless paper, temperatures of 520-5900° F. and pressure of 0.04 pounds per square inch and a dwell time of 1 to 1.5 seconds are sufficient. Carbonless paper is also protected with chip board on the top and bottom so contact with the molten LDPE is prevented along the longitudinal seam.

The use of this laminate as a wrapper for reams of copy paper often causes the polyethylene layer to adhere to the sheet of paper immediately adjacent the longitudinal seam. There is a need in the prior art for a wrapper for reams of paper that does not damage or bond to the paper being packaged.

It is an object of the invention to provide a wrapper for paper sealed by heat without damaging the paper.

It is another object of the invention to provide a heat shield on the inner surface of the wrapper to protect the paper.

It is another object of the invention to selectively place a heat shield to allow the proper amount of bonding.

It is another object of the invention to provide a heat shield in the form of a varnish applied during the formation of the wrapper.

These and other objects of the invention will become apparent to one of ordinary skill in the art after reviewing the disclosure of the invention.

### SUMMARY OF THE INVENTION

The wrapper for a ream of paper has an inner surface coated with polyethylene. When the wrapper is formed about a ream of paper, the inner layer overlaps and contacts the outer layer along a longitudinal seam. The polyethylene layer is used to create a seal with the application of heat. Areas of the inner surface in proximity to a heat source during the heat sealing process and where a seal will not be beneficial are covered with a heat shield, such as a varnish. In this way, damage to the paper is avoided. The varnish includes Styrenated Acrylic polymer, with Kaolin Clay and ink. Other possible varnishes include acrylics, clay coatings, Styrene Butadiene Rubber (SBR) latex, polyvinylidene chloride, silicone and inks. The varnish is applied to the wrapper during the same manufacturing process as the polyethylene coating.

### BRIEF DESCRIPTION OF THE DRAWINGS

FIG. 1 is a view of the outer surface of the wrapper.

FIG. 2 depicts the inner surface of the wrapper.

FIG. 3 is a cross-section of the wrapper.

FIG. 4 is a view of the manufacturing process for the wrapper.

### DETAILED DESCRIPTION OF THE INVENTION

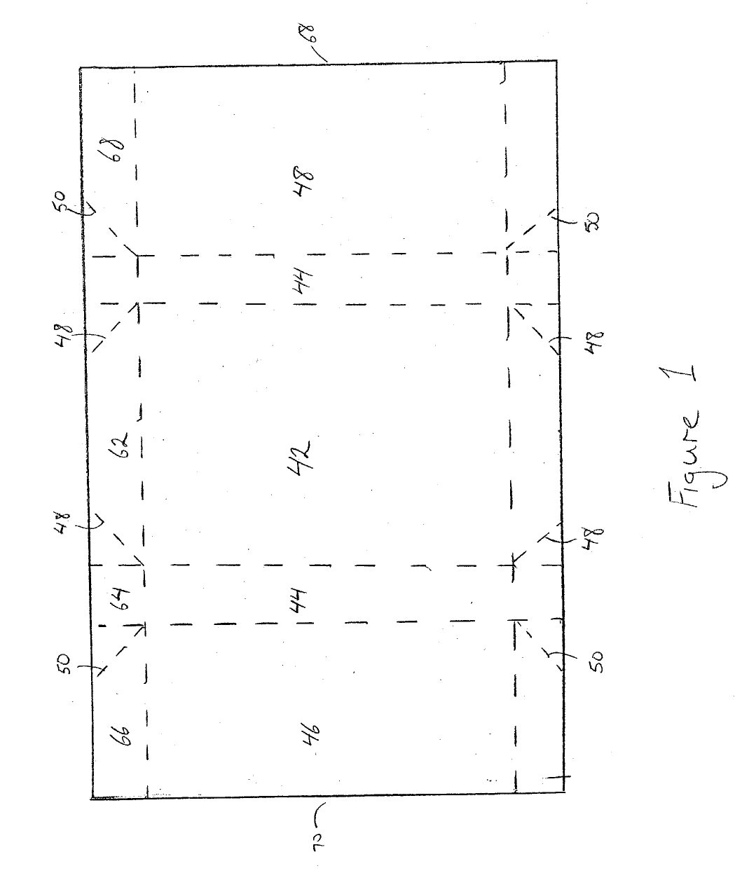

The wrapper is folded about a ream of paper. During the folding process, panels are formed in the wrapper to encapsulate the ream of paper. These panels include a set of middle panels covering the top, bottom and sides of the paper, and two sets of end panels, folded inwardly and sealed to form the ends of the package. FIG. 1 shows an exemplary wrapper, with the dotted lines indicating where the wrapper is folded. Given the flexible nature of the wrapper, fold lines do not need to be formed in the wrapper itself.

The ream of paper is placed in the center of the wrapper on central panel 42. The size of the panel 42 corresponds to the size of the paper being wrapped. The wrapper is folded about the ream of paper, with the panels 44 covering the sides of the ream and the bottom panels 46, 48 folded to cover the bottom of the ream of paper. The bottom panels overlap and are heat sealed together. The end panels are folded inwardly with the two side end panels 66, 68 folded against the ream of paper and the central end panel 62 overlying these two panels. The end panels are folded along lines 48-50 to complete the end seal.

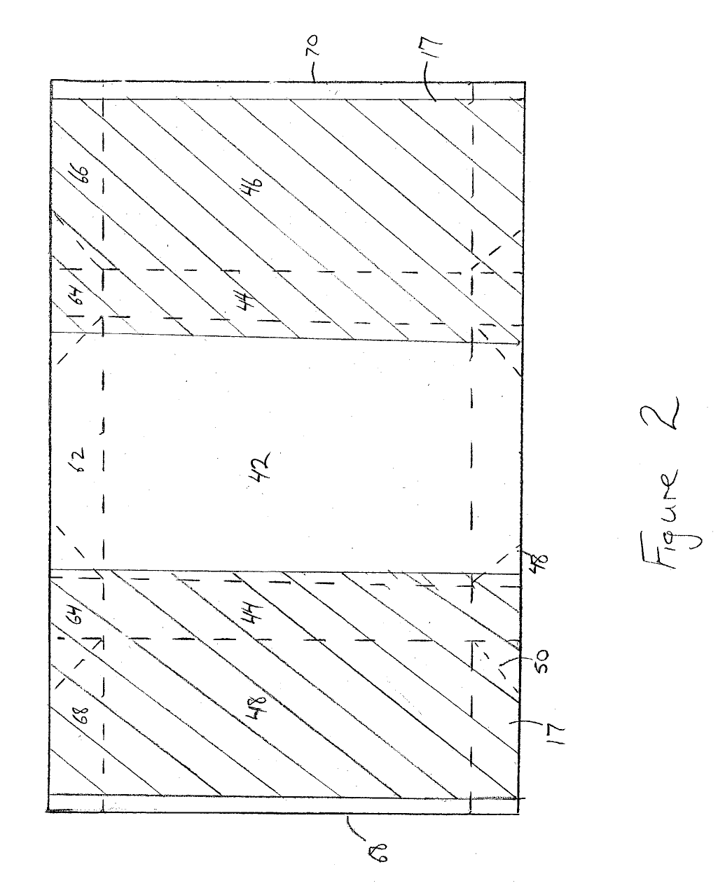

FIG. 2 shows the inner surface of the wrapper, with the application of varnish along the left edge 68 and right edge 70. The varnish 17 may be a Styrenated Acrylic polymer latex, with Kaolin Clay and ink, and is spaced from the left edge to expose a strip of polyethylene coating that will heat seal to the outside of the panel 46. The ink provides color to the varnish so the coverage of the varnish is visible. On both sides, the varnish covers the side panels 44 and slightly covers the middle panel 42. As can be seen, part of the triangular piece formed by fold lines 48 must remain unvarnished to expose polyethylene for the heat seal along the end seal. The varnish is shown terminating short of the right edge to expose the polyethylene coating. This enables either panel 46, 48 to be folded on top of the other and create a heat seal but the varnish may extend all the way to the right edge 70. The space between the left edge 68 and the beginning of the varnish 17 is up to one inch. The varnish extends from the left edge at least until the fold line between the side panel 44 and panel 48. By enabling the amount of varnish applied to the central end panel 62, the opening force to break the end seal can be varied. The greater extent of varnish used, the less area available for heat sealing.

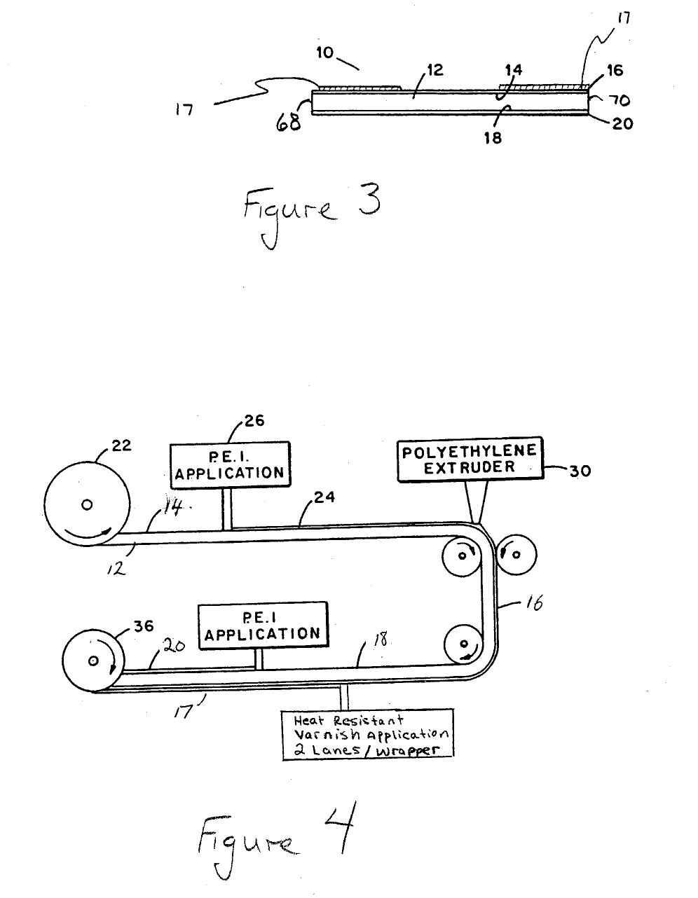

FIG. 3 shows a cross-section of the laminate 10, as seen along lines 3-3 of FIG. 2. As can be seen, the substrate 12, such as Kraft paper, a laminate of paper/film or a film, has a P.E.I. layer 20 applied to one surface 18 and a low density polyethylene layer 16 applied to the second surface 14. The varnish 17 is applied on top of the LDPE layer. A primer of P.E.I. is preferably placed over the top of the print. The prefered primer is Polymin P #014811 made by BASF Wyandotte Corp. in Parsippany, N.J. which contains Polyethyleneimine and Polyaziridine.

If the print area is small, especially in the seal regions, the primer could be placed under the print. The primer coating can be 100% coverage or pattern coated. A pattern coating will give seals that are easier to open because the bond will fluctuate between areas of high bond force to areas of low bond force. Areas of low bond force within the seal region facilitate opening and separation of plies.

The preferred composition of the laminate is as follows:

Kraft Paper

20 lbs/3,000 ft² to 80 lbs/3,000 ft². Typically 50 lbs/3,000 ft².

5 LDPE Coating

lbs/3,000 ft² to 20 lbs/3,000 ft². Typically 10 lbs/3,000 ft².

Dried Varnish Coating

0.05 lbs/3,000 ft² to 2 lbs/3,000 ft². Typically 0.4 lbs/3,000 ft²

Dried Primer Coating

0.005 lbs/3,000 ft² to 2 lbs/3,000 ft². Typically 0.02 lbs/3,000 ft².

Kraft paper substrate 12 can be substituted with a paper/film laminate or a single film substrate.

The preferred composition of the heat shield varnish is:

| | | |
|---|---|---|
| Styrenated Acrylic Polymer | 30.6% | wt. |
| Kaolin Clay | 20.0% | wt. |
| Ink - blue | 0.1% | wt. |
| Volatiles | 49.3% | wt. |

Styrenated Acrylic has a Tg of 0-10° F., and a melt temperature of 350 to 370° F. Clay addition levels of 15% or higher give good release of the bottom sheet from the wrapper. Clay levels below 15% have had a slight tack of the varnish to the bottom sheet. Without the use of clay, the varnish would have the potential of sticking to the bottom of the sheet with enough force to distort the paper or dislodge portions of the surface fibers.

The effect of the P.E.I. coating on a laminate can be seen from comparing the four laminates listed below.

1. P.E.I 100% Coverage

Print 2 color 25% Coverage

50# White Extensible Kraft

10# LDPE Chevron 1019

0.4# Heat Shield Varnish—No Clay

2. P.E.I. 100% Coverage

Print 2 color 25% Coverage

50# White Extensible Kraft

10# LDPE Chevron 1019

0.6# Heat Shield Varnish—No Clay

3. No P.E.I.

Print 2 color 25% Coverage

50# White Extensible Kraft

10# LDPE Chevron 1019

0.4# Heat Shield Varnish—No Clay

4. No P.E.I.

Print 2 color 25% Coverage

50# White Extensible Kraft

10# LDPE Chevron 1019

0.6# Heat Shield Varnish—No Clay

Heat Seal Settings:

Heat Seal Unit Manufacturer=WillPemco

Side Seal Temperatures=345° F.

Girth Seal=300° F.

Dwell Time=2 seconds.

Pressure=1 to 2 psi

The characteristics of each laminate is summarized in the following Table:

| | | Heat Shield | | Sticking |
|---|---|---|---|---|
| | | Coat Weight | Seal | to Bottom |
| Laminate | P.E.I. | (lbs/3,000 ft²) | Strength | Sheet |
| 1 | Yes | 0.4 | Excellent | Slight |
| 2 | Yes | 0.6 | Excellent | Slight |
| 3 | No | 0.4 | Poor | Slight |
| 4 | No | 0.6 | Poor | Slight |

Comments:

1. The heavier heat shield varnish coating weight induced a slight CD cur. Curl can cause the wrapper machine to jamb, therefore the lower varnish coating weight was preferred.

2. The slight tack to the bottom sheet did not tear the sheet, but was not considered desirable because surface fiber could become loosened or the sheet could become distorted if the tack level increased.

The effect of the amount of filler in the varnish is seen by comparing the various laminates listed below:

| | | Filler | Heat Shield | Sticking |
|---|---|---|---|---|
| | Filler | Content | Coat Weight | to Bottom |
| Laminate | Type | % Wt | (lbs/3,000 ft²) | Sheet |
| 1 | Clay | 15 | 0.4 | Very Slight |
| 2 | Clay | 20 | 0.4 | None |
| 3 | Al₂O₃ | 15 | 0.4 | Very Slight |
| 4 | Al₂O₃ | 20 | 0.4 | Very Slight |
| 5 | None | 0 | 0.4 | Slight |

Comments:

1. Clay was preferred because it performed better than Aluminum Oxide as a release agent and clay is lower cost.

FIG. 4 shows the preferred method for forming the laminate. A supply reel 22 feeds a substrate 12 toward a first P.E.I. applicator 26 applying a layer 24 onto the first surface 14 of the substrate. This P.E.I. application is optional. It is only needed when other priming methods cannot be used. Downstream, a polyethylene extruder 30 applies a layer of polyethylene 16 to the top surface of the laminate. Over the polyethylene layer, a varnish applicator provides two lanes of varnish 17 to the laminate. A P.E.I. applicator applies a layer of P.E.I. 20 to the second surface 18 of a laminate. The completed laminate is fed toward a take-up reel 36.

While the invention has been described with reference to a preferred embodiment, variations and modifications would be apparent to one of ordinary skill in the art, and the invention encompasses such variations and modifications.

What is claimed is:

1. A wrapper for a ream of paper, comprising:
a substrate having an inner surface and an outer surface and a left edge and right edge,
a layer of heat sealable polymer on said substrate inner surface, and
a layer of heat shield material applied over said heat sealable polymer layer.

2. The wrapper of claim 1, wherein said layer of heat shield material is spaced from said left edge of said substrate.

3. The wrapper of claim 1, wherein said heat shield layer is spaced from said left and right edge of said substrate.

4. The wrapper of claim 1, wherein said heat sealable polymer is polyethylene.

5. The wrapper of claim 1, wherein said heat shield material is a varnish.

6. The wrapper of claim 1, wherein said varnish is Styrenated Acrylic polymer with Kaolin Clay, and ink.

7. The wrapper of claim 1, wherein said varnish is a Styrenated Acrylic polymer latex.

8. The wrapper of claim 1, wherein said varnish is polyvinylidene chloride.

9. The wrapper of claim 1, wherein said varnish is a silicone coating.

10. The wrapper of claim 1, wherein said varnish is an ink.

11. The wrapper of claim 1, further comprising a layer of polyethyleneimine on said substrate outer surface.

12. A tubular wrapper for a ream of paper, comprising:
a top panel,
a left panel connected to said top panel,
a right panel connected to said top panel,
a first bottom panel connected to said left panel,
a second bottom panel connected to said right panel,
a longitudinal seam formed on overlap of said first bottom panel and said second bottom panel,
said top panel, left panel, right panel, first and second bottom panels forming a tubular form having a top edge, a bottom edge, an inner surface and an outer surface,
a heat sealable polymer layer on said inner surface, and
a heat shield layer on said heat sealable polymer layer.

13. The tubular wrapper of claim 12, wherein said heat sealable polymer is polyethylene.

14. The tubular wrapper of claim 12, wherein said heat shield layer does not cover said heat sealable polymer layer at said overlap of said first and second bottom panels.

15. The tubular wrapper of claim 12, wherein said heat shield layer is spaced from a free edge of said first bottom panel.

16. The tubular wrapper of claim 12, wherein said heat shield layer is selected from the group of Styrenated Acrylic polymer latex with Kaolin Clay and ink.
